(19) United States
(12) Patent Application Publication
(10) Pub. No.: US 2026/0042621 A1
(43) Pub. Date: Feb. 12, 2026

(54) HANDLING APPARATUS FOR CONTAINERS, IN PARTICULAR PHARMACEUTICAL CONTAINERS, SYSTEM FOR PROCESSING SUCH CONTAINERS, AND USE OF A HANDLING APPARATUS

(71) Applicant: Bausch + Stroebel SE + Co. KG, Ilshofen (DE)

(72) Inventors: Andreas Boehmike, Ilshofen (DE); Benjamin Spang, Ilshofen (DE); Florian Barthelmess, Ilshofen (DE); Manuel Wallisch, Ilshofen (DE)

(21) Appl. No.: 19/361,268

(22) Filed: Oct. 17, 2025

Related U.S. Application Data
(63) Continuation of application No. PCT/EP2024/059633, filed on Apr. 9, 2024.

(30) Foreign Application Priority Data
Apr. 19, 2023 (DE) 10 2023 109 939.6

(51) Int. Cl. B65G 54/02; B65B 3/00; B65B 43/46

(52) U.S. Cl. CPC B65G 54/02; B65B 3/003; B65B 43/46; B65G 2201/0235

(57) ABSTRACT

A handling apparatus, for example for a system for processing containers, in particular pharmaceutical containers, features a carrier body configured as a hollow body, at least one drive device, at least one drive element arranged in the carrier body and operatively connected to the at least drive device, and a traveler device having at least one output element arranged on the outside of the carrier body. The drive element and the output element include or form a particular magnet arrangement. The traveler device is configured to be movable with at least one degree of freedom relative to the carrier body and at least one guide device for guiding the movement of the traveler device relative to the carrier body. The handling apparatus can be part of a system for processing containers.

### CROSS-REFERENCE TO RELATED APPLICATIONS

This application is a continuation patent application of international application number PCT/EP2024/059633, filed on Apr. 9, 2024, and claims the benefit of priority of German application number 10 2023 109 939.6, filed on Apr. 19, 2023, the contents of both applications being incorporated herein by reference in their entireties and for all purposes.

### FIELD

The present disclosure relates to a handling apparatus, for example for a system for processing containers. The containers are in particular pharmaceutical containers, for example, vials, syringes, cartridges, or ampoules. The containers can be stable containers, which can stand independently on a set-down surface, or non-stable containers, which must be held by means of a holding device.

Furthermore, the present disclosure relates to a system for processing in particular pharmaceutical containers, which system comprises a frame for placing on a set-down surface and at least one handling apparatus.

The present disclosure also relates to a use of a handling apparatus.

### BACKGROUND

In systems for processing pharmaceutical containers, handling apparatuses or transport apparatuses are used to transport the containers for processing at different stations. These include, for example, at least one weighing station, a filling station and a closing station. Transport apparatuses require a drive device, which is typically arranged in a substructure of a frame, wherein a drive element projects through an opening into a cleanroom, in which the containers are processed. Various types of movement, such as rotation and displacement (e.g. lifting and lowering) are required to operate the stations, which places high demands on the sealing of the drive elements between the cleanroom and the substructure. This entails the risk of unnecessary abrasion by particles and associated contamination in the cleanroom. Germs possibly being spread independently of abrasion can also be a problem.

The above challenges can be overcome by using robotic apparatuses as handling apparatuses in the cleanroom. However, this leads to high complexity and high production costs, although there is not always a technical need to use a robotic system. Robotic systems can also have the disadvantage that the processing rate for the containers is relatively low in comparison to the use of other types of transport apparatuses, which use, for example, wheels or belt conveyors for container transport.

An object underlying the present disclosure is to provide a handling apparatus that has advantageous hygienic properties.

### SUMMARY

In a first aspect of the present disclosure, a handling apparatus, for example for a system for processing in particular pharmaceutical containers, is provided. The handling apparatus comprises a carrier body configured as a hollow body, at least one drive device and at least one drive element arranged in the carrier body and operatively connected to the at least one drive device. The handling apparatus further comprises a traveler device having at least one output element arranged on the outside of the carrier body, wherein the drive element and the output element comprise or form a respective magnet arrangement. The traveler device is configured to be movable with at least one degree of freedom relative to the carrier body and at least one guide device for guiding the movement of the traveler device relative to the carrier body.

In a second aspect of the present disclosure, a system for processing containers, in particular pharmaceutical containers, is provided. The system comprises a frame for placing on a set-down surface, at least one handling apparatus in accordance with the first aspect which is arranged on the frame and at least one processing station for the containers, wherein the at least one handling apparatus is part of or forms the processing station.

In a third aspect of the present disclosure, a use of a handling apparatus in a system for processing in particular pharmaceutical containers is provided.

### BRIEF DESCRIPTION OF THE DRAWINGS

The foregoing summary and the following description may be better understood in conjunction with the drawing figures, of which:

FIG. 1 is a schematic representation of a system in accordance with the present disclosure for processing containers, comprising a handling apparatus in accordance with the present disclosure;

FIG. 2 is a simplified and schematic representation of a handling apparatus in accordance with the present disclosure in a preferred embodiment;

FIG. 3 is a perspective representation of the handling apparatus in accordance with the present disclosure in a partial view;

FIG. 4 is a longitudinal sectional view of the handling apparatus from FIG. 3;

FIG. 5 is an enlarged representation of detail A in FIG. 4;

FIG. 6 is a perspective partial representation of the handling apparatus in an exploded representation;

FIG. 7 is a further perspective partial view of the handling apparatus in an exploded representation;

FIG. 8 shows the handling apparatus in accordance with the present disclosure in a simplified schematic representation as part of a processing station of the system in accordance with the present disclosure;

FIG. 9 shows the handling apparatus in accordance with the present disclosure in a simplified schematic representation as part of a processing station of the system in accordance with the present disclosure;

FIG. 10 shows two handling apparatuses in accordance with the present disclosure in a simplified schematic representation as part of a processing station of the system in accordance with the present disclosure; and

FIG. 11 shows two handling apparatuses in accordance with the present disclosure in a simplified schematic representation as part of a processing station of the system in accordance with the present disclosure.

### DETAILED DESCRIPTION

Although the present disclosure is illustrated and described herein with reference to specific embodiments, the present disclosure is not intended to be limited to the details shown. Rather, various modifications may be made in the details within the scope and range of equivalents and without departing from the present disclosure.

The present disclosure relates to a handling apparatus, for example for a system for processing in particular pharmaceutical containers, the handling apparatus comprising a carrier body configured as a hollow body, at least one drive device, at least one drive element arranged in the carrier body and operatively connected to the at least one drive device, a traveler device with at least one output element arranged on the outside of the carrier body, wherein the drive element and the output element comprise or form a respective magnet arrangement, wherein the traveler device is configured to be movable with at least one degree of freedom relative to the carrier body, and at least one guide device for guiding the movement of the traveler device relative to the carrier body.

In the handling apparatus, the at least one drive element can be moved via the at least one drive device within the receiving space enclosed by the carrier body. The drive element is magnetically coupled to the at least one output element via the magnet arrangement. Via a movement of the drive element, the output element can be moved on the outside of the carrier body and, via the movement of the output element, the traveler device can be moved relative to the carrier body with at least one degree of freedom and can be guided via the at least one guide device.

The present disclosure incorporates the consideration that the magnetic coupling between the drive element and the output element can prevent their contact with each other. In particular, this provides the advantage that the drive side can be mechanically and preferably hygienically decoupled from the driven side. For example, it is provided that the drive element is arranged in the less clean receiving space, which communicates, for example, with a zone of a machine substructure or frame of the system for processing containers, whereas the output element is positioned in the cleanroom of the system, in which the containers are processed. This leads to a lower risk of abrasion and/or of spreading germs and promotes the hygienic properties of the handling apparatus in accordance with the present disclosure.

In accordance with the above, it is advantageous, for example, if the carrier body comprises a closed wall arrangement, via which a receiving space of the carrier body is sealed relative to the outside, in particular in a pharmaceutically compliant manner. In this case, the at least one drive element is arranged in the receiving space and the at least one output element is arranged on the outside, in particular in the cleanroom of the system. The closed wall arrangement preferably provides a sterile barrier through which no particles can pass, which prevents contamination of the cleanroom.

For example, it may be provided that a pharmaceutically compliant seal is achieved in that the carrier body is connected, in particular in one piece, to a separating element of the system, which separating element separates the outside with a zone of high cleanliness relative to a zone in the substructure with lower cleanliness. The connection is made, for example by material bonding, by welding.

Advantageously, a modular structure of the handling apparatus is possible, wherein, for example, only the traveler device is replaced and the drive side remains unchanged. For example, traveler devices are provided that are container-specific or processing-specific for containers and are configured as format parts.

The modular structure makes it possible, for example, to use the same at least one drive device and the same at least one drive element for different traveler devices.

The traveler device can preferably be replaced mechanically. For example, a further handling apparatus, which may, for example, be robotic, is arranged in the cleanroom of the system in order to remove the traveler device and replace it with a different type of traveler device.

Maintenance processes on the handling apparatus are advantageously made easier.

The present disclosure advantageously makes zone separation possible between a first zone, in particular a cleanroom zone of the system, and a second zone, which is located, for example, in the substructure of the system below a frame and with which the receiving space of the carrier body communicates.

Simplified disassembly of the handling apparatus can advantageously be carried out via the magnetic coupling by magnetically decoupling the traveler device from the at least one drive element. Further requirements, such as loosening screw connections or the like, can advantageously be dispensed with.

The present disclosure advantageously makes improved cleaning of the handling apparatus and of the system possible, for example within the cleanroom. WIP processes (WIP, washing in place) are advantageously conceivable.

The possible degrees of freedom for the movement of the traveler device can advantageously be determined via the configuration of the at least one drive device, without the need for structural changes to be made to the outside of the carrier body and in particular within the cleanroom.

The magnet arrangements can be configured in different ways, for example depending on the application. The use of permanent magnets and/or electromagnets is conceivable. The orientation of the magnetic field can be ensured by selecting a suitable drive element and/or a suitable output element.

A correct magnetic coupling of the traveler device with the at least one drive element can advantageously be achieved, for example, by measuring the magnetic field.

Advantageously, the present disclosure also provides the option of overload protection for the handling apparatus since, advantageously, there is not a fixed connection between the at least one output element and the at least one drive element, so that an overload on the drive side as well as on the functional side (outside the carrier body) is not transmitted or is only transmitted to a limited extent to the other side as a result of the decoupling.

The wall arrangement of the carrier body may, for example, be made of pharmaceutically compliant stainless steel and thus have preferred cleaning properties.

It may be provided that the at least one drive device comprises or forms a linear drive, wherein the at least one drive element in the carrier body is in particular rectilinearly displaceable along a carrier body axis, for displacing the traveler device along the carrier body, wherein the at least one guide device comprises a translational guide. The linear drive can be used to achieve a reciprocating movement of the traveler device, for example a lifting movement for raising and lowering the traveler device. Compared to conventional transport apparatuses, this can prevent the spreading of germs and/or abrasion of the drive elements being guided through a frame of the system. The carrier body, in particular its wall arrangement, preferably provides a sterile barrier.

It is advantageous if a wall arrangement of the carrier body forms a guide element of the translational guide. This allows a structurally simple configuration to be achieved by eliminating the need for a separate guide element.

The traveler device can preferably comprise at least one holding body, which is directly or indirectly connected to the at least one output element, for example via a further component of the traveler device, and at least one guide element, which is arranged on the holding body. The guide element cooperates with a further guide element, for example the wall arrangement of the carrier body, to guide the traveler device during displacement.

The at least one guide element is preferably a guide roller, which rolls, for example, along the wall arrangement of the carrier body. During displacement of the traveler device in the longitudinal direction of the carrier body, the guide roller may, for example, roll along the wall arrangement.

A rotational axis of the at least one guide roller is preferably aligned perpendicularly to the carrier body axis. In the present case, this can be understood in particular to mean that a plane perpendicular to the carrier body axis contains the rotational axis of the guide roller.

The guide roller is advantageously made of such a material that no or only insignificant abrasion occurs during rolling, in order to avoid contamination on the outside of the carrier body.

Multiple guide elements and in particular multiple guide rollers can be held on the at least one holding body, which improves the guiding properties.

It is advantageous if the at least one holding body, in particular in the case of a cylindrically configured carrier body, comprises or forms a holding ring which surrounds the carrier body, preferably completely.

In particular in the latter case, it may be advantageous if the multiple guide elements have an identical angular distance relative to one another with respect to the carrier body axis.

In a preferred embodiment of the present disclosure, for example, more than two guide elements, preferably more than four guide elements, and in particular eight or more guide elements, may be provided.

It is advantageous if the traveler device has two holding bodies axially opposite each other with respect to the at least one output element. In the axial direction relative to the carrier body axis, the at least one output element can accordingly be positioned between the holding bodies and the at least one guide element arranged thereon, preferably the multiple guide elements. In this way, the guidance during displacement is carried out on both sides of the output element, which improves the guiding properties.

Advantageously, the holding bodies and/or the guide elements arranged thereon are configured identically, which simplifies the structural configuration of the handling apparatus.

Alternatively or additionally to the displacement, for example to the lifting movement, of the traveler device, it is preferably possible with the handling apparatus to carry out a rotational movement of the traveler device relative to the carrier body.

It may be provided that the at least one drive device comprises or forms a rotary drive, wherein the at least one drive element in the carrier body is drivable in rotation about a carrier body axis in order to rotate the traveler device, at least partially, about the carrier body, wherein the at least one guide device preferably comprises a rotary guide. This allows the traveler device and, for example, a tool held thereon to be rotated.

In combination with the displacement, it is, for example, possible to carry out pick-and-place movements via the handling apparatus, such as those used when placing stoppers or caps on the containers.

With the rotary drive, it is, for example, provided that the traveler device comprises at least one support body for supporting directly or indirectly, for example via a further component of the traveler device, on the outside of the carrier body, wherein the support is preferably provided on the wall arrangement of the carrier body. The at least one output element is preferably configured to be rotatable about the carrier body axis relative to the at least one support body.

The at least one support body is advantageously secured against rotation relative to the carrier body. In the present case, this can, for example, be understood to mean that, when the at least one drive element rotates, there is no rotation of the support body on the carrier body but there is a rotation of the at least one output element.

Accordingly, “rotation of the traveler device,” at least partially, as mentioned above, can preferably also be understood in particular to mean that it is not the traveler device as a whole that rotates, but only one component or multiple components thereof, whereas other components are not rotated. For example, the at least one output element rotates, whereas the at least one support body does not rotate relative to the carrier body. On the other hand, it may be provided that the traveler device as a whole can rotate about the carrier body axis.

The traveler device preferably comprises at least one bearing element, which is arranged and effective between the at least one support body and at least one output element or a coupling element connected to the at least one output element. The bearing element improves the guiding properties of the rotary guide.

The bearing element can be a rolling bearing and/or a plain bearing, wherein the rolling bearing is advantageous in practice for avoiding abrasion.

The at least one bearing element is preferably a bearing ring.

For example, the at least one bearing element, in particular the bearing ring, is arranged radially on the outside with respect to the coupling element or the at least one output element, wherein the at least one support body overlaps the at least one bearing element radially on the outside.

For example, the bearing element is connected to the support body via a holding member, such as a ring holding the bearing ring, wherein the holding member is supported directly or indirectly on the coupling element or on the output element. A further holding member, for example a holding ring, can fix the bearing element and in particular the bearing ring to the coupling element or to the output element.

In particular, in the case of a cylindrical configuration of the carrier body, it may be advantageous if the at least one support body comprises or forms a support ring which surrounds the carrier body and preferably completely surrounds it.

It may be provided that the traveler device comprises two support bodies axially, with respect to the at least one output element, opposite each other relative to the carrier body axis. The support bodies are preferably configured identically. The two support bodies improve the guiding properties of the rotary guide. Advantageously, two bearing elements and in particular bearing rings are provided, which are preferably arranged on the respective support body.

It is in particular advantageous if the at least one support body is the at least one holding body.

This simplifies the structural configuration of the handling apparatus. Separate holding bodies and support bodies are not required. For example, the support body is supported on the carrier body indirectly via the guide element or the guide elements. For the rotational movement, the at least one output element can be rotated relative to the holding body/support body. For any displacement, the traveler device with the at least one output element and with the at least one holding body/support body can be moved along the carrier body. In this embodiment, references to the holding body can be regarded as references to the support body, and vice versa.

It can be advantageous if the at least one output element is freely rotatable about the carrier body axis and/or is rotatable by 360° about the carrier body. This allows for a versatile configuration of the handling apparatus.

An anti-rotation device may be provided for the at least one output element in order to limit the rotational movement to a specified angular range.

It is conceivable that the anti-rotation device is axially limited so that, in a combined displacement and rotational movement, it is, for example, possible to carry out a free rotation or 360° rotation about the carrier body on the one hand or limited rotation about the carrier body on the other hand, depending on the axial position of the traveler device.

It is advantageous if the traveler device is held in position on the carrier body solely via the magnet arrangements, wherein the traveler device is free of a connecting element for connecting to the carrier body. However, the drive of the traveler device is preferably completely decoupled from the drive side. Reference is made to the aforementioned advantageous properties of the handling apparatus.

The at least one drive element is preferably free of contact with a wall arrangement of the carrier body on the inside, wherein the inside refers to a receiving space enclosed by the carrier body.

Advantageously, the at least one output element is free of contact with a wall arrangement of the carrier body on the outside, whereby any abrasion of the output element on the wall arrangement can in particular be avoided.

In a preferred configuration of the present disclosure, the at least one drive element and/or the at least one output element comprise or form a receiving element with a plurality of receptacles, in which the magnet elements of the respective magnet arrangement are received. The receiving element is, for example, configured to be disk-shaped.

It may optionally be provided that the respective magnet arrangements are implemented as a Halbach array.

The magnetic elements are preferably permanent magnets.

In a preferred embodiment, the at least one output element can surround the carrier body in a ring shape and can in particular form a closed ring. In the case of a plurality of output elements, which are discussed below, a respective output element advantageously surrounds the carrier body in a ring shape.

The carrier body can be configured to be cylindrical at least in portions, for example as a column when aligned in the height direction, wherein the traveler device is, as it were, slipped over the carrier body, and wherein the at least one output element completely surrounds the carrier body.

For use in the system for processing containers, it is advantageous, for example, if the handling apparatus comprises a holding part connected to the traveler device and projecting away from the carrier body. For example, the holding part projects radially relative to a carrier body axis.

The holding part may, for example, form a tool for the containers, or a tool for the containers may be arranged on the holding part.

A rotating body on which the containers are placeable, for example a turntable, is provided as a tool, for example.

A rotating body on which the containers are holdable, for example a star wheel with a plurality of container receptacles for the containers, is provided as a tool, for example.

A filling tool for filling at least one container is provided as a tool, for example, wherein at least one filling needle is held on the filling tool. During a displacement, the filling needle may, for example, be inserted into the containers in order to fill them, or may, conversely, be lifted out of the containers.

The tool may, for example, comprise a closing tool for closing at least one container on which at least one closing element is held, for example a stopper or a cap. For example, a combined displacement and rotational movement can be used to use the closing tool.

The tool may be a gripping tool for gripping at least one container. For this purpose, for example, a rotational movement, a displacement, or a combined rotational movement and displacement is used.

A gap can in each case be provided between the drive element and the wall arrangement and/or between the output element and the wall arrangement.

In a preferred embodiment of the present disclosure, the traveler device can comprise a plurality of output elements. For example, this makes it possible to transmit larger forces from the at least one drive device to the traveler device, wherein a plurality of drive elements is advantageously provided.

The output elements are, for example, arranged in layers one above the other in the axial direction of the carrier body and/or connected to one another.

It may be provided that the output elements are connected to the coupling element, the bearing element being arranged between this and the support body.

A plurality of drive elements may be provided. The drive elements are, for example, arranged in layers one above the other in the axial direction of the carrier body and/or connected to one another. For example, a connection is made to a holding part, which is, for example, configured to be sleeve-shaped and connected to a drive shaft.

For example, a respective drive element and a respective output element are assigned to each other and arranged in a common plane perpendicular to the carrier body axis of the carrier body.

The plurality of drive elements may form a package of drive elements, in particular when connected to one another. The same applies to the output elements.

The at least one drive device may be configured in various ways, for example to be electrical, magnetic, pneumatic, hydraulic, or as a combination of these properties.

The at least one drive device may comprise a drive shaft that is drivable in rotation and/or displaceably, wherein the at least one drive device is coupled to the drive shaft. The driving force is transmitted to the at least one drive element via the drive shaft.

It may prove to be advantageous if the drive shaft is a hollow shaft. For example, this makes it possible for the handling apparatus to comprise a clamping element extending through the hollow shaft, which clamping element clamps the carrier body in the axial direction relative to a set-down element of the handling apparatus. For example, the clamping element engages in an end-side cover element of the carrier body, which closes a cylindrical surface part. The clamping element is supported, for example, in the machine substructure.

The carrier body may, for example, be configured to be cylindrical in portions, whereby the aforementioned cylindrical surface part is provided, for example.

The carrier body may comprise a guide part, on which the traveler device is guided, and a base part, which are axially adjacent to one another, wherein the base part is configured to be radially widened relative to the guide part, in particular conically, and comprises or forms a contact region for a frame of the system on the side facing away from the guide part. The contact region may be a contact flange for abutment against an edge of a through-opening in the frame. Alternatively, the contact region may be connected to the frame, for example by material bonding, in particular by welding.

The handling apparatus may comprise a sensor device, with which a position of the traveler device relative to the carrier body is detectable and a corresponding sensor signal is providable, wherein the at least one drive device is controllable depending on the sensor signal. This allows versatile operation of the handling apparatus, wherein the position of the traveler device may be monitored. For example, a Hall sensor, which is arranged on the inside of the carrier body, is used as a sensor element. For example, a disk-shaped sensor element rests on a drive element.

For example, the magnet arrangement of the at least one output element may be detected so that a separate magnet element can be saved.

As already mentioned, the present disclosure also relates to a system. A system in accordance with the present disclosure for processing containers, in particular pharmaceutical containers, comprises a frame for placing on a set-down surface, at least one handling apparatus of the type described above, which is arranged on the frame, and at least one processing station for the containers, wherein the at least one handling apparatus is part of or forms the processing station.

The advantages already explained in connection with the handling apparatus in accordance with the present disclosure can also be achieved with the system. The object underlying the present disclosure can also be achieved via the system.

Advantageous embodiments of the system in accordance with the present disclosure follow from advantageous embodiments of the handling apparatus in accordance with the present disclosure. In this respect, reference is made to the above statements.

The frame is, for example, a machine substructure, as already mentioned.

For example, the frame comprises an in particular plate-shaped separating element, which separates a first zone from a second zone, wherein the first zone has a higher cleanliness requirement than the second zone, and wherein the first zone is, for example, a cleanroom zone.

The handling apparatus passes through, for example, a through-opening in the separating element, wherein the carrier body and the traveler device are arranged in the first zone and the at least one drive device is arranged in the second zone, wherein the first zone is sealed, preferably in a pharmaceutically compliant manner, relative to the second zone. For example, the handling apparatus stands via the base part with the contact flange on the edge of the through-opening, where a seal between the zones is present. A receiving space of the carrier body can communicate with the second zone and have lower cleanliness requirements than the first zone. The zone separation can be achieved via the carrier body, for example via its wall arrangement.

It may be provided that the carrier body is connected to the separating element. A one-piece connection, for example a material-bonded connection, is in particular conceivable here. If manufactured from metal, the carrier body can be welded to the separating element, for example.

The system may comprise a control device, which is coupled to the at least one drive device in order to control the operation of the handling apparatus. Advantageously, the control device can control the operation of the system as a whole.

The system may comprise two handling apparatuses and a control device for controlling the operation of the system, wherein the control device is coupled to the drive devices of both handling apparatuses for synchronized movement of the traveler devices of both handling apparatuses with one another. This makes it possible to operate two handling apparatuses together to carry out complex tasks and use complex tools. It may be provided that both handling apparatuses comprise at least one drive device together. For example, a common drive device for a displacement is conceivable, wherein separate drives may be provided for a respective rotational movement.

The traveler devices are coupled, for example, via a joint arrangement to interconnected joint members, wherein a tool for processing the containers is arranged on the joint arrangement. The respective joint member is formed, for example, by the holding part or is connected thereto. A system with a joint arrangement may, for example, be used at a filling station for the containers, wherein a feed movement of one or more filling needles can be implemented in combination with a displacement.

The present disclosure also relates to a use. A use in accordance with the present disclosure provides for the use of the handling apparatus of the type described above in a system for processing in particular pharmaceutical containers.

Advantageous exemplary embodiments of the use in accordance with the present disclosure follow from advantageous embodiments of the handling apparatus in accordance with the present disclosure. Reference is made to the above statements.

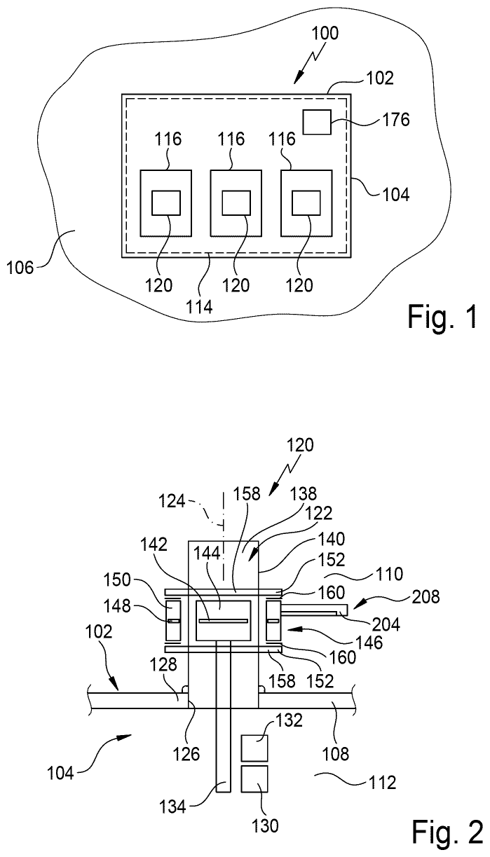

FIG. 1 shows, in a schematic representation, an advantageous embodiment of a system in accordance with the present disclosure for processing containers (not shown in the drawing), the embodiment being denoted as a whole by reference numeral 100. The containers in the present case are in particular pharmaceutical containers, which may, for example, be vials, syringes, cartridges, or ampoules.

In the present case, the system 100 comprises a frame 102, which forms a machine substructure 104 and can be placed on a set-down surface 106 of the system 100. The frame 102 comprises a separating element 108, in particular a plate-shaped separating element 108 in the present case, for example in the form of a tabletop. The separating element 108 separates a first zone 110 of the system 100 from a second zone 112.

The first zone 110 has a higher cleanliness requirement than the second zone 112 and forms, for example, a cleanroom. An isolator device 114 of the system 100 may be provided, which covers the frame 102 and provides an atmosphere of a predetermined type in the first zone 110. For example, a laminar flow (LF) of a gas may be provided in order to prevent the swirling of particles.

The system 100 is in particular suitable for processing pharmaceutical products, which may be highly effective or even toxic, which is why the use of the handling apparatus in accordance with the present disclosure with improved hygienic properties is advantageous. The system 100 may comprise a plurality of processing stations 116, wherein the handling apparatus is in each case part of a processing station and such a processing station may comprise more than one handling apparatus.

The reference numeral 120 denotes the handling apparatus in accordance with the present disclosure as a whole, wherein a preferred embodiment is described below.

For this purpose, the schematic and simplified representation of the handling apparatus 120 in accordance with FIG. 2 is discussed first, followed by a specific configuration in accordance with

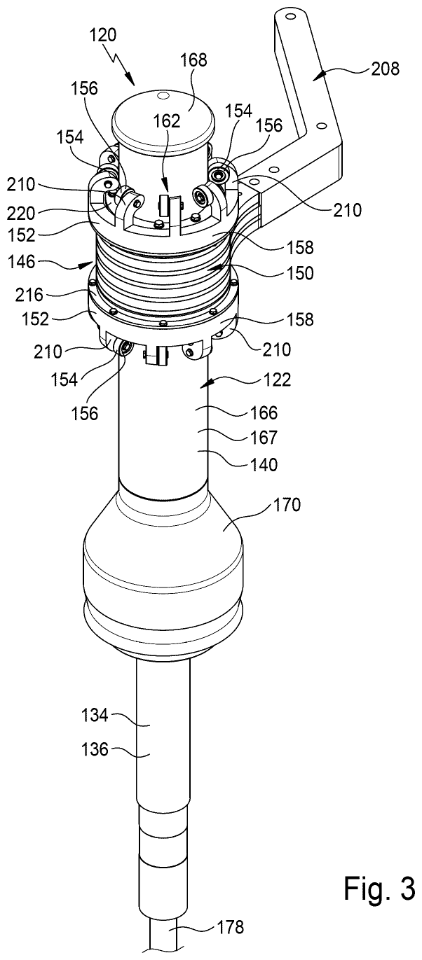

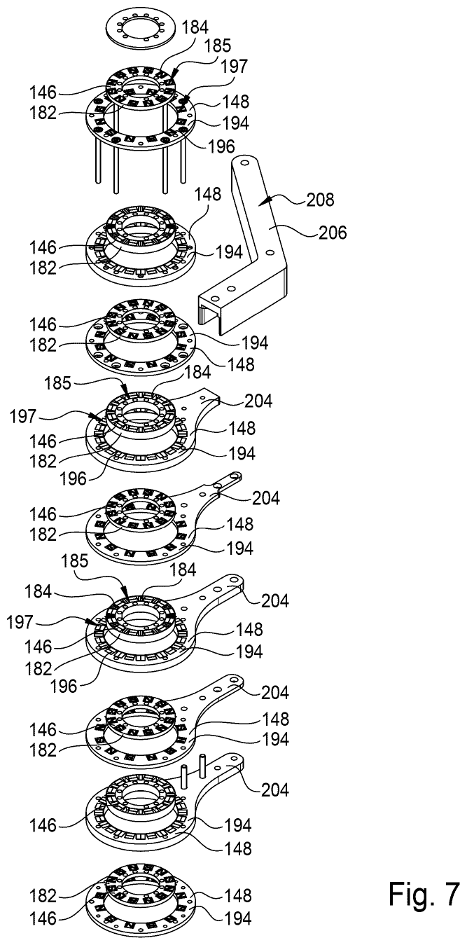

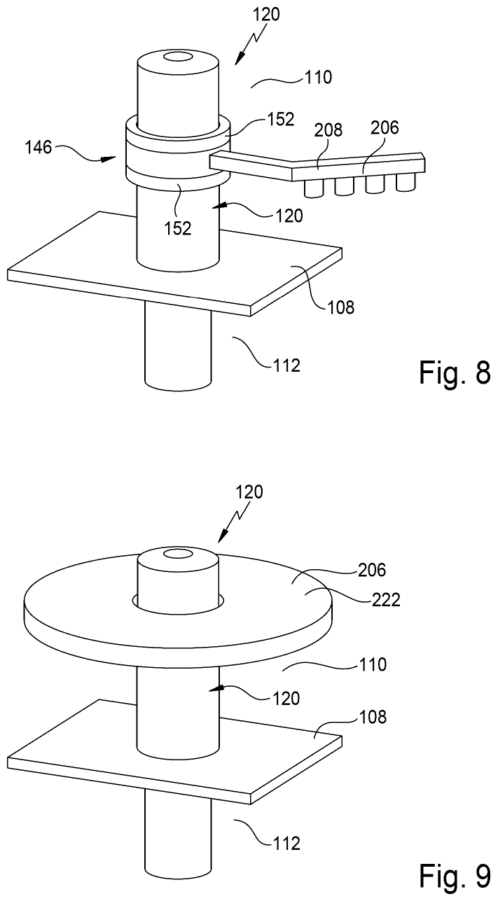

FIGS. 3 to 7, whereupon applications of the handling apparatus 120 in the system 100 are explained with reference to the examples in FIGS. 8 to 11.

The handling apparatus 120 comprises a carrier body 122, which defines a carrier body axis 124. In the present case, the carrier body axis 124 is aligned in the vertical direction and in particular vertically, for example perpendicularly to a plane of the separating element 108. The carrier body 122 can accordingly also be referred to as a column.

However, the present disclosure is not limited to this orientation of the handling apparatus 120.

The handling apparatus 120 passes through a through-opening 126 in the separating element, wherein it abuts an edge 128. At the edge 128, there is a pharmaceutically compliant seal between the zones 110, 112.

At least one drive device of the handling apparatus 120 is arranged in the second zone 112. In the present case, there is a first drive device 130, which forms a linear drive, and a second drive device 132, which forms a rotary drive.

The drive devices 130, 132 may be configured in various ways, for example to be electrical, magnetic, pneumatic, hydraulic or as a combination of these properties.

A drive body can be acted upon via the respective drive device 130, 132. In the present example, the drive body is a drive shaft 134, in particular a hollow shaft 136.

The hollow shaft 136 extends into a receiving space 138 of the carrier body 122, wherein the receiving space is enclosed in the region of the first zone 110 by a wall arrangement 140 of the carrier body.

A drive element 142 is drivable via the drive shaft 134 for displacement in the axial direction along the carrier body axis 124 and/or for rotation about the carrier body axis 124. The drive element 142 is arranged in the receiving space 138. In the present case, a plurality of drive elements 142 is provided, which are connected to one another to form a package 144.

The handling apparatus 120 comprises a traveler device 146 arranged on the outside of the carrier body 122. The traveler device 146 comprises at least one output element 148. In the present case, a plurality of output elements 148 is provided, which are connected to one another to form a package 150.

The output element 148 in the present case is indirectly connected to a respective holding body 152, wherein two holding bodies 152 are arranged axially on opposite sides of the output element 148 and, in the present case, of the package 150. At least one guide element 154 is held on the holding body 152, in the present case in the form of a guide roller 156. The guide roller 156 can roll along the outside of the wall arrangement 140, which forms a guide element.

In the present example, the holding body 152 simultaneously forms a support body 158 for indirectly supporting the output element 148, in particular the package 150, on the carrier body 122.

A bearing element 160 is in each case arranged between the support body 158 and the output element 148, in particular the package 105.

The configuration explained above comprises guide devices, namely, on the one hand, a translational guide 162 during displacement of the traveler device 146 and, on the other hand, a rotary guide 164 during rotation of the traveler device 146 about the carrier body axis 124, wherein the at least one output element 148 in the present case rotates, but the support body 158 does not.

For a more detailed description of the configuration of the handling apparatus 120, reference is made to FIGS. 3 to 7.

The carrier body comprises a guide part 166, which in the present case is configured to be hollow-cylindrical and comprises the wall arrangement 140. The guide part 166 comprises a cylindrical surface part 167 and a cover part 168 closing said cylindrical surface part 167 on the end side. At the end opposite the cover part 168, the guide part 166 is connected to a base part 170 of the carrier body 122. In the present case, the base part 170 widens conically in portions in the direction of the frame 102 and forms a contact flange 172 at a contact region. The contact flange 172 abuts the edge 128, wherein the base part 170 engages in the through-opening 126.

Alternatively, it is conceivable for the carrier body 122 to be connected to the separating element 108, for example by welding the wall arrangement 140 to the edge 128. This allows reliable sealing to be achieved in the region of the through-opening 126, and thus pharmaceutically compliant zone separation.

The hollow shaft 136 passes through the through-opening 126 and in the present case stands on a support part 174. The drive device 132 for the linear drive engages with the support part 174, which can be raised and lowered. As a result, the hollow shaft 136, and thus the drive element 142, is raised or lowered.

The drive device 132 for the rotary drive is held, for example, on the support part 174. The hollow shaft 136 is driven in rotation via the drive device 132.

As a result, a combined displacement and rotation can be carried out since the drive device 132 can also be raised or lowered.

A control device 176 of the handling apparatus 120 makes it possible to control the operation. For this purpose, the control device 176 is operatively connected to the drive devices 130, 132. The control device 176 may be a control device of the system 100.

It is understood that a bearing element (not shown in the drawings) may be present for mounting the hollow shaft 136 on the support part 174.

The handling apparatus 120 comprises a clamping element 178. In the present case, the clamping element 178 passes through the hollow shaft 136 and extends from the second zone 112 to the cover part 168.

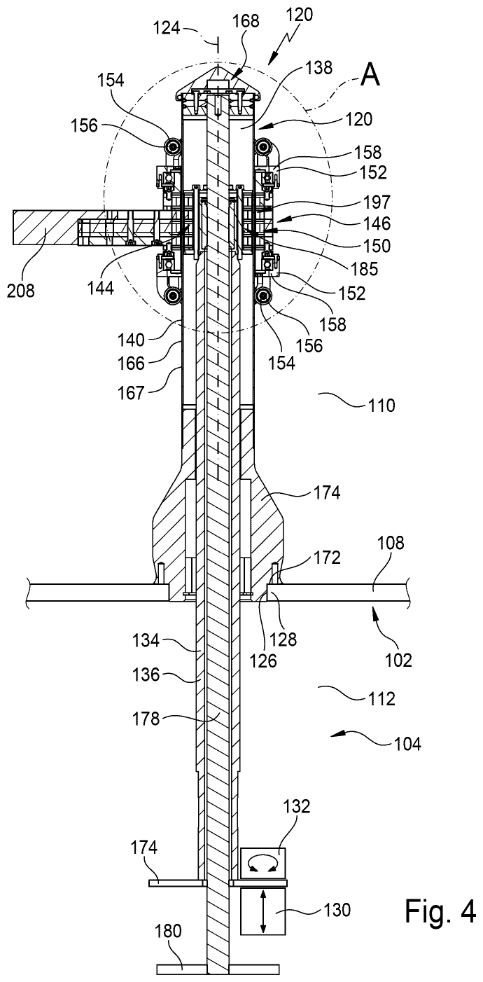

The multi-part cover part 168 (FIGS. 4 to 6), for example, is fixedly connected to the clamping element 178. At the opposite end, the clamping element 178 is clamped to a support part 180 of the machine substructure 104. This serves, for example, to fix the handling apparatus 120 to the machine substructure 104.

At the end with the cover part 168, the receiving space 138 is sealed relative to the cleanroom in the first zone 110. The seal in the present case is pharmaceutically compliant. Further sealing is effected via the wall arrangement 140, wherein sealing is additionally effected via the base part 170.

The receiving space 138 can communicate with the second zone 112 and have reduced cleaning requirements in comparison to the first zone 110. The handling apparatus 120 can thus project into the first zone 110, but the introduction of foreign particles, and thus contamination of the zone 110, can be prevented.

As mentioned, the handling apparatus comprises at least one drive element 142, in the present case a plurality thereof. In the present example, nine drive elements are provided, although their number could be different. A corresponding number of output elements 148 is provided. By increasing the number of drive and output elements 142, 148, the force exerted on the traveler device 146 can be increased, for example.

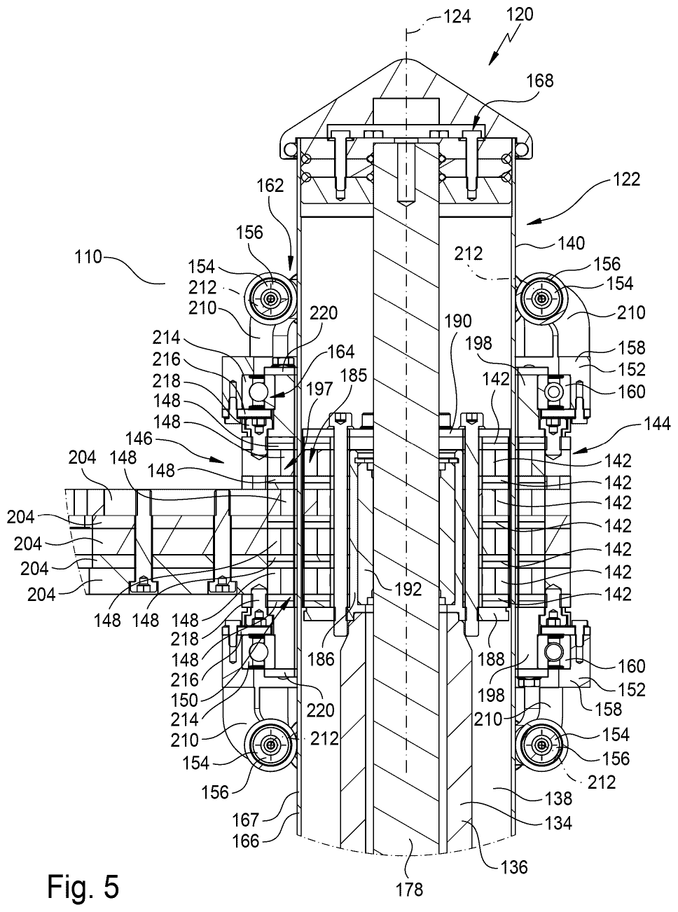

As can be seen in particular in FIGS. 5 to 7, each drive element 142 is configured to be disk-shaped and comprises a disk-shaped receiving element 182. Receptacles for magnet elements 184 are present in the receiving element 182. The magnet elements 184 can be received in a predefined position and arrangement in order to generate the desired magnetic field.

The magnetic fields generated by the various drive elements 142 can differ from one another so that in combination the desired effect is achieved. The magnet elements 184 are permanent magnets and are selected according to the desired number, orientation, strength, and arrangement.

The magnet elements 184 together form a magnet arrangement 185.

The drive elements 142 combined to form the package 144 are arranged in layers one above the other. In the present case, a connection is made via a screw connection, although the connection could be of a different type.

For holding the drive elements 142, a sleeve-shaped holding part 186 is present, which has a contact element 188 for a drive element 142. Screw elements pass through a cover element 190 and the drive elements 142 and are screwed to the holding part 186. The holding part 186 is preferably connected in a rotationally fixed manner to the hollow shaft 136. A bearing element 192 is arranged between the holding part 186 and the clamping element 178 for radial and axial support. The bearing element 192 is, for example, a linear rolling bearing, specifically a linear ball bearing.

The drive elements 142 in the present case are free of contact with the wall arrangement 140 on the inside of the carrier body 122. Accordingly, there is a gap between the drive elements 142 and the wall arrangement 140. With regard to a particularly reliable mounting of the traveler device 146, it is advantageous if this gap is relatively small and, for example, in the millimeter range.

As can be further seen in particular in FIGS. 5 to 7, the output elements 148 are also disk-shaped in the present case. In each case, a disk-shaped receiving element 194 is provided, in which receptacles for magnet elements 196 are formed. The magnet elements 196 are permanent magnets and are selected according to the desired number, orientation, strength, and arrangement. The magnet elements 196 together form a magnet arrangement 197.

The magnet arrangements 185 and 197 cooperate to transmit the driving force of the drive devices 130, 132 to the traveler device 146. In addition, the traveler device 146 is held on the carrier body 122 solely by the magnetic force between the magnet arrangements 185, 197. No further connecting elements are provided.

Each drive element 142 is assigned a respective output element 148, wherein the elements 142, 148 are located in a common plane, which is aligned perpendicularly to the carrier body axis 124 (FIG. 5).

To form the package 150 the output elements 148 are arranged in layers axially one above the other and thereby form the package 150.

To form the package 150, the output elements 148 can be held together. For this purpose, a corresponding coupling element 198 is provided. Two coupling elements 198 lie axially opposite each other with respect to the output elements 148. The coupling elements 198 are connected to each other, in the present case by a screw connection, although a different type of connection is conceivable. Screw elements pass through a coupling element 198, the package 150, and engage with the further coupling element 198.

The output elements 148 in the present case are each configured to be annular, completely surrounding the carrier body 122. In the present case, the coupling elements 198 are also configured to be annular and completely surround the carrier body 122.

The output elements 148 are free of contact with the wall arrangement 140 on the outside. Instead, a gap is provided between the output elements 148 and the wall arrangement 140. Correspondingly, there is a gap between the coupling elements 198 and the wall arrangement 140.

During the displacement and/or rotation of the output elements 148, abrasion on the carrier body 122 can thus be prevented. At the same time, friction relative to the wall arrangement 140 is eliminated.

In the present case, at least one of the output elements 148 comprises a holding part 204. The holding part 204 is formed as a projection in the direction away from the carrier body 122, for example in the radial direction relative to the carrier body axis 124.

In the present example, five output elements 148 comprise a holding part 204, although this number could be different. The holding parts 204 can be connected to one another directly or indirectly, for example via a screw connection.

A tool 206 of the handling apparatus 120 is held on the holding parts 204, which tool is shown only partially in FIGS. 3 to 7. Here, a holding arm 208 is shown, on which further components for processing the containers may be arranged or held.

When the output elements 148 move, the tool 206 is also moved, which makes it possible to process the containers.

The holding body 152 in the present case is configured as a holding ring, which completely surrounds the carrier body 122. The holding body 152 comprises projections 210 for holding the guide rollers 156. The projections 210 project in the direction away from the output elements 148. For example, they can initially run axially and then in the direction of the carrier body 122.

A guide roller 156 is arranged on the respective projection 210. A rotational axis 212 of the guide roller 156 runs in a plane perpendicular to the carrier body axis 124.

The projections 210 and guide rollers 156 are each configured identically. In the present case, multiple projections 210 and guide rollers 156 are present, which in particular have an equal angular distance from one another in the circumferential direction around the carrier body axis 124. The present exemplary embodiment in each case shows eight projections 210 and guide rollers 156, although their number could also be different.

Projections 210 and guide rollers 156 are arranged on both holding bodies 152. The respective configurations are identical, as can be seen, for example, in FIGS. 4 to 6.

The guide rollers 156 can be used to implement a translational guide during displacement of the traveler device 146 in the axial direction. In terms of material, the guide rollers 156 are designed such that no or no relevant abrasion and thus no contamination of the first zone 110 occurs. The guidance is provided axially on both sides of the output elements 148, above and below them.

For providing the rotary guide, the bearing elements 160 are provided, which in the present case are configured as rolling bearings and each comprise a bearing ring 214. The use of a plain bearing is conceivable.

The bearing ring 214 may, for example, rest on an annular holding member, which is connected to the holding body 152, for example via a screw connection. The holding member 216 can rest directly or indirectly, in the present case via a screw element 218, on the package 150 or on the coupling element 198.

Furthermore, for example, a holding member 220 may be provided, which rests on the coupling element 198 and the bearing ring 214 and is connected to the coupling element, for example via a screw connection.

In the present case, the bearing ring 214 is arranged radially outside the coupling element 198. The holding body 152 overlaps the bearing ring 214 radially on the outside (FIG. 5) with an axially extended edge.

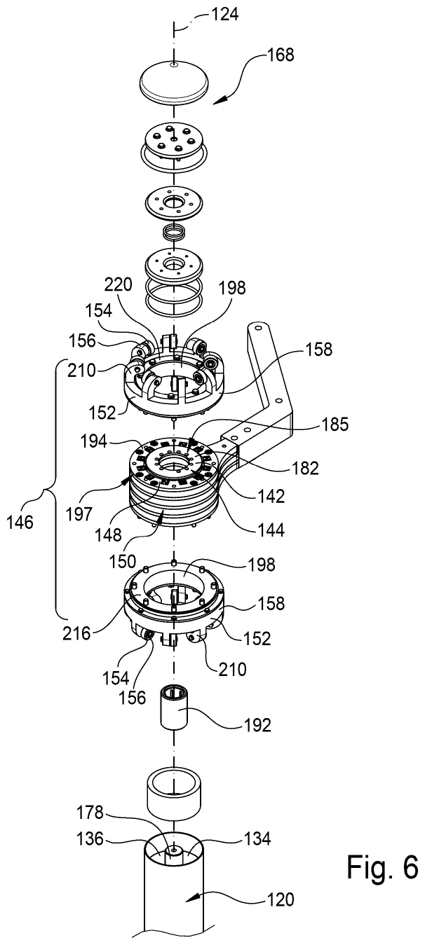

The holding body 152, the bearing ring 214, and the coupling element 198 may be provided as a preassembled structural unit, connected, for example, via the holding members 216, 220, as shown in FIG. 6. The structural units may be connected to one another via screw connections and may receive, for example, the package 150 between them.

When the output elements 148 rotate, the coupling elements 198 also rotate, whereas the holding bodies 152 and the guide rollers 156 are decoupled via the bearing rings 214. The holding body 152 is secured against rotation along with the guide rollers 156.

The axial displacement of the output elements 148 and their rotation about the carrier body axis 124 can be combined depending on the control of the drive devices 130, 132. Accordingly, a displacement and a rotation are possible at the same time.

The configuration of the handling apparatus 120 has hygienic advantages. It also makes a modular structure possible. For example, just the traveler device 146 can be replaced, while the drive side remains unchanged. Depending on the requirements and tools for processing the containers and accordingly depending on the processing station, different types of traveler devices 146 may be used. Alternatively or additionally, various types of holding parts 204, tools 206, and/or holding arms 208 may be provided. Different traveler devices 146 may, for example, be configured as format parts.

At the outset, the advantages and effects of the present disclosure were described in detail; reference is made to these explanations at this point.

FIG. 8 shows the handling apparatus 120 in a simplified representation together with a tool 206, for example for pick-and-place applications. The tool 206 may, for example, be a gripping tool, with which the containers are raised, moved, and lowered again. Alternatively, the tool 206 may, for example, be a closing tool, with which closing elements can be attached to the containers. In both of the aforementioned cases, a displacement and a rotation of the traveler device 146 come into consideration, for example.

FIG. 9 shows an application involving a tool 206 in the form of a rotating body 222. The containers can be transported standing on the rotating body 222, which in the present example is configured as a turntable. In particular, a rotational movement of the traveler device 146 is used here, although a displacement is also conceivable.

An alternative rotating body 222 may be configured, for example, as a star wheel, which comprises container receptacles for the containers and is used, for example, in a transport device.

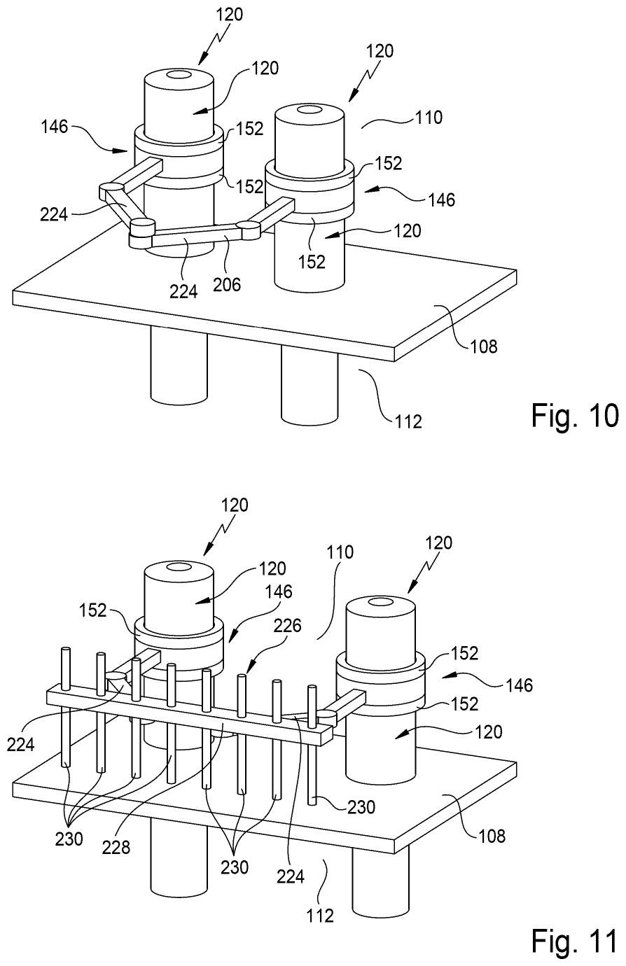

FIG. 10 shows a coupling of two handling apparatuses 120 at a processing station 116. A respective joint member 224 is held in an articulated manner on the respective holding part 204, wherein the joint members 224 are connected to one another in an articulated manner. In the present case, the joint axes run parallel to the carrier body axes 124.

The drive devices 130, 132 can be synchronized via the control device 176. A common linear drive may be provided here.

Depending on the respective rotational position of the traveler devices 146, the joint members 224 are pivoted relative to one another so that even complex tasks can be accomplished. For example, in addition to a rotational movement, a change in length can be effected by changing the distance of the joint members from the carrier bodies 122. The configuration in accordance with FIG. 10 may, for example, be used in gripping processes and/or closing processes. However, it is also conceivable to use it in a filling station.

FIG. 11 shows a configuration with a tool 206 in the form of a filling tool 226. The configuration is similar to FIG. 10, but the joint members are not directly connected to one another; rather, they are each connected in an articulated manner to a holding element 228. Schematically illustrated filling elements in the form of filling needles 230, via which the containers are filled, are held on the holding element 228.

In this use, a displacement is used, for example, to raise and lower the filling needles 230 as well as a respective rotational movement of the traveler devices 146, which can change the distance of the filling tool 226 from the containers. A change in distance is based, for example, on a respective direction of rotation of the traveler devices 146, wherein co-rotations and counter-rotations are possible.

It is understood that the above applications are merely exemplary and that the present disclosure is not limited thereto.

### LIST OF REFERENCE NUMERALS

100 System
102 Frame
104 Machine substructure
106 Set-down surface
108 Separating element
110 First zone
112 Second zone
114 Isolator device
116 Processing station
120 Handling apparatus
122 Carrier body
124 Carrier body axis
126 Through-opening
128 Edge
130, 132 Drive devices
134 Drive shaft
136 Hollow shaft
138 Receiving space
140 Wall arrangement
142 Drive element
144, 150 Package
146 Traveler device
148 Output element
152 Holding body
154 Guide element
156 Guide roller
158 Support body
160, 192 Bearing element
162 Translational guide
164 Rotary guide
166 Guide part
167 Cylindrical surface part
168 Cover part
170 Base part
172 Contact flange
174, 180 Support part
176 Control device
178 Clamping element
182, 194 Receiving element
184, 196 Magnet element
185, 197 Magnet arrangement
186, 204 Holding part
188 Contact element
190 Cover element
198 Coupling element
210 Projection
206 Tool
208 Holding arm
212 Rotational axis
214 Bearing ring
216, 220 Holding member
218 Screw element
222 Rotating body
224 Joint member
226 Filling tool
228 Holding element
230 Filling needle

1. A handling apparatus for a system for processing pharmaceutical containers, the handling apparatus comprising:
a carrier body configured as a hollow body;
at least one drive device;
at least one drive element arranged in the carrier body and operatively connected to the at least one drive device;
a traveler device with at least one output element arranged on an outside of the carrier body; and
at least one guide device for guiding movement of the traveler device relative to the carrier body,
the at least one drive element and the at least one output element each comprising or forming a magnet arrangement, and
the traveler device configured to be movable with at least one degree of freedom relative to the carrier body.

2. The handling apparatus according to claim 1, wherein:
the carrier body comprises a closed wall arrangement, and
the closed wall arrangement seals a receiving space of the carrier body relative to the outside.

3. The handling apparatus according to claim 1, wherein:
the at least one drive device comprises or forms a linear drive,
the at least one drive element is rectilinearly displaceable along a carrier body axis for displacing the traveler device along the carrier body, and
the at least one guide device comprises a translational guide.

4. The handling apparatus according to claim 3, wherein a wall arrangement of the carrier body forms a guide element of the translational guide.

5. The handling apparatus according to claim 3, wherein the traveler device comprises:
at least one holding body directly or indirectly connected to the at least one output element, and
at least one guide element arranged on the at least one holding body.

6. The handling apparatus according to claim 5, wherein at least one of the following applies:
the at least one guide element comprises multiple guide elements that are held on the at least one holding body, and
the at least one guide element is a guide roller having a rotational axis aligned perpendicularly to the carrier body axis.

7. The handling apparatus according to claim 5, wherein at least one of the following applies:
the at least one holding body comprises or forms a holding ring that surrounds the carrier body, wherein the at least one guide element comprises a plurality of guide elements having an angular distance relative to one another with respect to the carrier body axis, and
the traveler device comprises two holding bodies axially opposite each other with respect to the at least one output element.

8. The handling apparatus according to claim 5, wherein:
the at least one drive device comprises or forms a rotary drive,
the at least one drive element is drivable in rotation about a carrier body axis to rotate the traveler device, at least partially, about the carrier body, and
the at least one guide device comprises a rotary guide.

9. The handling apparatus according to claim 8, wherein:
the traveler device comprises at least one support body for supporting directly or indirectly on an outside of the carrier body, and
the at least one output element is configured to be rotatable about a carrier body axis relative to the at least one support body.

10. The handling apparatus according to claim 9, wherein the traveler device comprises at least one bearing element arranged between the at least one support body and at least one output element or a coupling element connected to the at least one output element.

11. The handling apparatus according to claim 10, wherein:
the at least one bearing element is arranged radially on the outside with respect to the coupling element or the at least one output element, and
the at least one support body overlaps the at least one bearing element radially on the outside.

12. The handling apparatus according to claim 9,
wherein at least one of the following applies:
the at least one support body comprises or forms a support ring that surrounds the carrier body;
the traveler device comprises two support bodies axially opposite each other with respect to the at least one output element; and
the at least one support body is the at least one holding body comprised by the traveler device, the at least one holding body being directly or indirectly connected to the at least one output element, and at least one guide element, which is arranged on the at least one holding body.

13. The handling apparatus according to claim 8,
wherein the at least one output element is freely rotatable about the carrier body axis and/or by 360° about the carrier body.

14. The handling apparatus according to claim 1,
wherein the traveler device is held in position on the carrier body solely via the magnet arrangements, wherein the traveler device is free of a connecting element for connection to the carrier body.

15. The handling apparatus according to claim 1,
wherein the at least one drive element is free of contact with a wall arrangement of the carrier body on an inside and/or wherein the at least one output element is free of contact with a wall arrangement of the carrier body on the outside.

16. The handling apparatus according to claim 1,
wherein the at least one drive element and/or the at least one output element comprise or form a receiving element with a plurality of receptacles, in which magnet elements of the respective magnet arrangement are received.

17. The handling apparatus according to claim 1, wherein the magnet arrangements are implemented as a Halbach array.

18. The handling apparatus according to claim 1, wherein the at least one output element surrounds the carrier body in a ring shape and forms a closed ring.

19. The handling apparatus according to claim 1, wherein the handling apparatus comprises a holding part connected to the traveler device and projecting away from the carrier body, the holding part forming a tool for the pharmaceutical containers, or the tool for the pharmaceutical containers is arranged on the holding part.

20. The handling apparatus according to claim 19,
wherein at least one of the following is provided as a tool:
a rotating body, on which the pharmaceutical containers are placeable or on which the pharmaceutical containers are holdable;
a filling tool for filling at least one of the pharmaceutical containers, wherein at least one filling needle is held on the filling tool;
a closing tool for closing at least one of the pharmaceutical containers, on which at least one closing element is held; and
a gripping tool for gripping at least one of the pharmaceutical containers.

21. The handling apparatus according to claim 1, wherein:
the traveler device comprises a plurality of output elements, and
the plurality of output elements are arranged in layers one above the other in an axial direction of the carrier body and/or are connected to one another.

22. The handling apparatus according to claim 1, further comprising a plurality of drive elements arranged in layers one above the other in an axial direction of the carrier body and/or are connected to one another.

23. The handling apparatus according to claim 22, wherein a respective drive element and a respective output element are assigned to each other and are arranged in a common plane perpendicular to a carrier body axis of the carrier body.

24. The handling apparatus according to claim 1, wherein:
the at least one drive device comprises a drive shaft that is drivable in rotation and/or displaceably, and
the at least one drive device is coupled to the drive shaft.

25. The handling apparatus according to claim 24, wherein:
the drive shaft is a hollow shaft, and
the handling apparatus comprises a clamping element extending through the hollow shaft, the clamping element clamping the carrier body in an axial direction relative to a set-down element of the handling apparatus.

26. The handling apparatus according to claim 1, wherein:
the handling apparatus comprises a sensor device, with which a position of the traveler device relative to the carrier body is detectable and a corresponding sensor signal is providable, and
the at least one drive device is controllable depending on the corresponding sensor signal.

27. A system for processing pharmaceutical containers, comprising:
at least one handling apparatus according to claim 1;
a frame for placing on a set-down surface; and
at least one processing station for the pharmaceutical containers,
the at least one handling apparatus being arranged on the frame, and
the at least one handling apparatus being part of or forming the at least one processing station.

28. The system according to claim 27, wherein:
the frame comprises a separating element that separates a first zone from a second zone,
the first zone has a higher cleanliness requirement than the second zone,
the at least one handling apparatus passes through a through-opening of the separating element,
the carrier body and the traveler device are arranged in the first zone,
the at least one drive device is arranged in the second zone, and
the first zone is sealed off from the second zone.

29. The system according to claim 28, further comprising a control device for controlling operation of the system, wherein:
the at least one handling apparatus comprises two handling apparatuses, and
the control device is coupled to the drive devices of the two handling apparatuses for synchronized movement of the traveler devices of the two handling apparatuses with one another.

30. The system according to claim 29, wherein:
the traveler devices are coupled via a joint arrangement with interconnected joint members, and
a tool for processing the pharmaceutical containers is arranged on the joint arrangement.
